(19) United States
(12) Patent Application Publication
(10) Pub. No.: US 2011/0042515 A1
(43) Pub. Date: Feb. 24, 2011

(54) ARRANGEMENT FOR PROVIDING ACTIVE FIRE PROTECTION IN AIRCRAFT

(75) Inventors: Berend Schoke, Twistringen (DE); Heinz-Peter Busch, Weyhe (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/935,716

(22) PCT Filed: Feb. 11, 2009
(86) PCT No.: PCT/EP2009/051555

§ 371 Date: Nov. 15, 2010

Related U.S. Application Data
(60) Provisional application No. 61/072,483, filed on Mar. 31, 2008.

(30) Foreign Application Priority Data
Mar. 31, 2008 (DE) 10 2008 016 421.6

(51) Int. Cl. A62C 3/08; A62C 2/06

(52) U.S. Cl. 244/129.2

(57) ABSTRACT

The invention relates to an arrangement for providing active fire protection in aircraft by means of at least one protective shield. According to the invention, the at least one protective shield is formed with an intumescent material, which in the event of a fire can be activated, in particular made to expand, in a controlled manner well below the initial temperature otherwise usual for intumescent materials of the order of 250° C. by means of an electrical heating device. The current temperature in the hold (preferably at various temperature measuring points) of the aircraft is measured by means of at least one temperature sensor and transmitted to a controlling and regulating device. In the event of a fire, the heating devices are activated and the intumescent reactions of the protective shields for providing fire protection are initiated within a temperature interval between 90° C. and 150° C.

### CROSS-REFERENCE TO RELATED APPLICATIONS

This application claims the priority of the U.S. patent application Ser. No. 61/072,483 filed Mar. 31, 2008 and of the German Patent Application No. 10 2008 016 421.6 filed Mar. 31, 2008, the entire disclosure of which application is hereby incorporated herein by reference.

### FIELD OF THE INVENTION

The invention relates to a device for active fire protection in aircraft by means of at least one protective shield.

### BACKGROUND OF THE INVENTION

Intumescent materials for fire protection generally are formed by a conventional organic plastic material and additives. In the case of a fire the intumescent material foams to form an inorganic material that is either not combustible at all or is flame retardant, whereon the fire retardant effect of the intumescent substances is based.

Such intumescent materials can, for example, be manufactured from polyurethane with added expandable graphite, wherein the expandable graphite multiplies in volume in the case of fire. As an alternative, intumescent materials can be produced on the basis of epoxy resins that comprise additives whose volume increases multiple times over when compared to the initial state.

This makes it possible, for example, in the case of fire to automatically seal from inside the pipes or ducts leading from the cargo compartment to the passenger compartment so that combustion gases cannot enter the passenger cabin from the cargo compartment. As a result of the effect of heat, the polyurethane that encloses the expandable graphite is essentially completely thermally decomposed. Due to the effect of fire the intumescent material is completely “carbonised”, thus forming a plastic-free inorganic material that is able, for example, to close off a pipe or duct in a fire-retardant manner and to stop any combustion gases from passing through it. For example, the product known under the trademark of “BayGraphit®” is an intumescent material that is suitable for incorporation in polyurethane.

Instead of polyurethane it is also possible to use silicon foam plastics and/or polyimide foam plastics in the manufacture of the intumescent material. If silicon foam plastics or polyimide foam plastics are used, these usually do not comprise expandable graphite. In this different composition, generally speaking some other intumescent material is added, for example the material known under the trademark of “Vermiculit®”, in order to achieve the desired fire-retardant effect. Furthermore, thermoplastic or duroplastic plastics with incorporated substances that under the effect of heat intumesce, for example expandable graphite or “Vermiculit®” can be used. Moreover, elastomers can comprise added intumescent characteristics. One example of this is the rubber compound “FS 195” manufactured by 3M®, which compound comprises added sodium silicate pellets.

Due to the coarseness of the expandable graphite or of the Vermiculit® additives, they are usually not suitable as functional fillers in the manufacture of intumescent coating materials such as lacquers or paints. In this case, preferably, mixtures comprising colloidal silicic acids, aluminium oxides, aluminium hydrates, aluminium silicates and other metal oxides are used as intumescent additives. The use of the above-mentioned additives makes it possible to produce, almost homogeneous intumescent coatings having thin material thickness, in order to protect components against the effects of fire.

All the above-mentioned materials compositions have in common that the desired intumescent reactions in the case of fire start only from a defined material-specific initial temperature. However, on the one hand this initial temperature must not be too low, so that there is no undesired intumescent reaction within the range of normal operating temperatures of the aircraft. On the other hand the initial temperature must also not be too high, so that in the case of a fire sufficiently fast and reliable reaction is ensured, thus resulting in the safe suppression of fire or combustion gases. In order to meet these requirements, usually an attempt is made to set an initial temperature of the intumescent materials around 250° C.

However, in relation to many components, for example components comprising temperature-sensitive materials or firewalls, controlled intumescence at a relatively low temperature that is only somewhat above the maximum permissible operating temperature of the aircraft is desirable. However, at present it is not possible to seal components or compartments off from each other in this manner in the case of fire, because present-day intumescent materials do not produce a reliable foaming reaction at an ambient temperature around 100° C.

It is thus the object of the invention to create a device for active fire protection in aircraft, in which device fire protection by means of controlled intumescence is possible at a temperature significantly below 250° C.

This object is met by a device with the characteristics of claim 1.

Because the at least one protective shield comprises an intumescent material that in the case of fire is activatable, in particular foamable, by means of an electrical heating apparatus, a good and above all controllable fire protection effect results in a relatively low temperature range from 100° C. to approximately 150° C., which range is far below the initial temperature for triggering the intumescent reaction of approximately 250° C. The protective shield according to the invention can be used as an inner seal in pipes or ducts or as surface protection, which is effective at least in some regions, for components within the aircraft.

According to an advantageous embodiment, at least one temperature sensor is connected to a control and regulating device in order to monitor the temperature in a fire region. As a result of this design it is possible to set, preferably in an infinitely variable manner, in a broad temperature range, a limit temperature in the fire region, from which limit temperature the controlled foaming, caused by the heating apparatus, of the protective shield formed by an intumescent material takes place. In this arrangement it is, usually not necessary to provide additional temperature sensors for the active fire protection device. Instead, the use of the temperature sensors that are necessary anyway for the function of the firefighting system in the aircraft and that are preferably arranged in the cargo compartment can be shared. In this case, if the automatic firefighting device in the cargo compartment is triggered, at the same time foaming or activating the intumescent material is initiated in that the electrical heating apparatus is switched on. However, separate temperature sensors are required if separate points in time of triggering are to be provided.

According to a further advantageous embodiment, the electrical heating apparatus is switched on in a temperature range from 90° C. to 150° C. by means of the control and regulating device in order to initiate controlled foaming of the intumescent material. In this way it becomes possible to use intumescent materials in the production of the at least one protective shield according to the invention, which intumescent materials comprise a relatively high initial temperature of, for example, up to 250° C. while nevertheless, in the case of a fire, activating in a controlled and reliable manner the active protective shield at a comparatively low ambient temperature of between 90° C. and 150° C. by foaming.

A further development of the device provides for the used intumescent material to automatically foam from a temperature of more than 250° C., in particular from a material-specific initial temperature. This results in a fallback position (redundancy) of the active fire protection system in case the electronic control and regulating device and/or the electrical heating apparatus no longer properly function/s, for example in the case of fire-related failure of the electrical emergency power supply or the like. Irrespective of the intended controlled-defined activation or triggering of the protective shield by means of the electrical heating apparatus when a temperature between 90° C. and 150° C. has been reached in the region of the fire or in the cargo compartment, in each case as soon as a limit temperature (initial temperature) of approximately 250° C. has been reached or exceeded, automatic triggering of the intumescent protective shield takes place by automatic foaming of the intumescent material that forms the protective shield.

Furthermore, it is provided for the electrical heating apparatus to comprise at least one heating wire. This ensures a simple construction of the electrical heating apparatus with the use of standardised components that are always available. By feeding an adequate heating current I_{Heiz} into the heating wire, the heating wire is heated to the initial temperature in the range of approximately 180° C. to 220° C., which temperature is required to trigger the intumescent reaction of the coating.

Moreover, the heating wires, which usually are at least to a limited extent flexible and if appropriate electrically insulated, can advantageously be integrated in protective shields with a more complex geometric shape. Examples of this include a grille or a grille-like structure, which grille at least in part comprises intumescent material.

Furthermore, it is possible to produce such a grille at least in part with electrical heating wires (resistive wires), wherein the grille, including the simple non-heatable wires, is preferably completely coated with an intumescent material and is arranged within a pipe or duct. In this way, for example, in the case of fire, a vent pipe or duct between a cargo compartment and a passenger cabin of an aircraft can be sealed gas-tight from toxic combustion gases and other disadvantageous effects of fire such as heat radiation by the active foaming of the intumescent material by means of the heating wires. Depending on the cross-sectional geometry of the pipe or duct to be closed off, such a grille will comprise a circular, elliptic, oval or quadrangular base area. If required, insulation pieces are to be provided at intersecting points of the grille so as to prevent short circuits between the heating wires and the remaining metal wires of the grille. Any metal wires of the grille that do not act as heating wires must also be coated with an insulating lacquer, in order to prevent undesirable bridging of non-insulated heating wires, and a reduction of the heating performance as a result of this.

Moreover, it is possible to use finished metal grilles (wire mesh etc.) around which at least in some sections or regions electrical heating wires are wound. If required, such metal grilles, too, need to be provided with additional electrical insulation, for example a phenolic resin insulating lacquer, dip insulation or the like, in order to stop uncontrolled bridging of the woven-in, if applicable also electrically-conductive, heating wires.

Furthermore, the protective shield for closing off the pipe or duct in the case of fire can comprise a honeycomb-like structure whose walls or cell surfaces facing towards the cargo compartment are at least in some sections coated with an electrically conductive paste that acts as an electrical heating apparatus. The walls of the honeycomb-like core structure which is formed by, for example, Nomex® paper is preferably coated continuously with a suitable intumescent material. In the case of fire an adequate heating current I_{Heiz} is transmitted through the edges, which are coated with the conductive paste, of the honeycomb-like core structure, as a result of which the intumescent material foams, swells or expands, thus safely closing off all the chambers of the honeycomb structure to prevent the passage of combustion gases. If an adequate height of the honeycomb structure is provided, for example a height of more than 5 cm in the direction of the longitudinal axis of the pipe or duct to be sealed, in the case of fire an adequately pressurisable seal is achievable as a result of the swollen intumescent material.

A further development of the device provides for the electrical heating apparatus to comprise at least one sheetlike heating element, in particular comprising an electrically resistive foil or the like. This variant of the heating apparatus can above all be used in an advantageous manner if an substantially planar, temperature-sensitive component for fire protection is to be coated or provided with a sheetlike protective shield comprising the intumescent material, and/or panels comprising the intumescent material, at least in some regions on one side or on both sides. In such a constellation the sheetlike electrical heating element is embedded in and/or underneath the intumescent layer, or is embedded in a panel comprising the intumescent material, so that all-over and simultaneous foaming of the protective shield is possible in the case of fire. Arranging the sheetlike heating element at the surface of the intumescent material is disadvantageous because in this case the heating element is directly exposed to the effect of the fire or of the radiation heat.

Irrespective of the above, the sheetlike heating element makes it possible to evenly and quickly heat up the intumescent material of the protective shield, as a result of which heating an even and quick foaming process is effected that contributes to a reduction in fire damage to the components to be protected.

Furthermore, a fleece, in particular a ribbon-shaped fleece, comprising adequate electrical conductivity can be used as a heating apparatus, which fleece additionally comprises an intumescent material. Such a fleece, for example a fleece comprising electrically-conductive carbon fibres or woven-in copper filaments, can, for example, be used for the fireproof sealing-off of gaps or joints between ceiling panels, wall panels or floor panels, which provide adequate fire resistance per se, within the cargo compartment of an aircraft. Preferably such a fleece is designed to be self-adhesive, which will facilitate its installation on the gaps or joints, and in an ideal case make it possible, in the case of fire, to hermetically seal off all the gaps or joints, openings and recesses within the cargo compartment, in addition to sealing off the pipes or ducts to stop combustion gases from passing through and in addition to the extinguishing agent Halon® that is commonly used in aviation.

Further advantageous embodiments of the device are presented in the further claims.

The drawing shows the following:

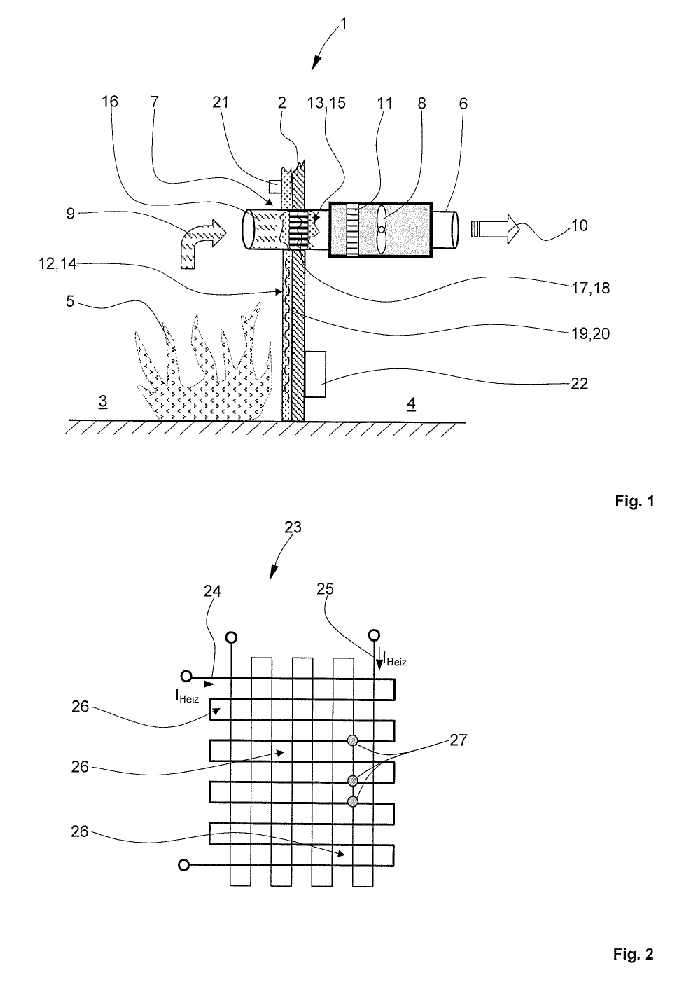

FIG. 1 a protective shield for closing off a pipe or duct, in the case of fire, so as to prevent combustion gases from passing through, as well as comprising a partition wall protected by a further protective shield, and

FIG. 2 a top view of a grille, comprising an intumescent material, as a protective shield to seal off a pipe or duct (venting or air conditioning pipe or duct) according to FIG. 1.

FIG. 1 shows an exemplary embodiment of the device for closing off a pipe or duct, in particular a vent pipe or duct, and for protecting a partition wall (firewall) in the case of fire.

A device 1 is arranged in the region of a partition wall 2 that extends perpendicularly between a cargo compartment 3 of an aircraft and a passenger compartment 4. In the cargo compartment 3 there is a fire 5. The cargo compartment 3 is connected to the passenger compartment 4 by means of a pipe or duct 6, in particular a ventilation pipe or duct which is accommodated in a connection opening 7 in the partition wall 2. Air from the cargo compartment 3 is conveyed in the direction of the arrows 9, 10 to the passenger compartment 4 by means of a blower 8, and is at the same time air conditioned by means of an air conditioning apparatus 11; in other words, in particular the temperature, the pressure and/or the humidity of the air conveyed to the passenger compartment 4 is set.

The device 1 comprises a temperature sensor 21 as well as two protective shields 12, 13 which in the exemplary embodiment shown in FIG. 1 comprise a panel 14 with an intumescent material to protect the partition wall 2 from the effect of the fire 5, and a grille 15 to seal off the pipe or duct 6 from combustion gases 16 emanating from the fire 5. Instead of the panel 14, the partition wall 2 can also comprise a coating up to 3 mm in thickness, comprising an intumescent material.

At least in some sections the grille 15 comprises an electrical heating apparatus 18 comprising heating wires 17 or resistive wires, wherein the heating wires 17 and the remaining metal wires (not designated with a reference character) of the grille 15 at least in some sections comprise a coating of a suitable intumescent material, i.e. are coated all round. The heating wires 17 of the grille 15 can at the same time also be used as grille wires.

The panel 14 that is arranged in front of the partition wall 2 can completely or at least in part comprise an intumescent material in which an electrical heating apparatus 19 is embedded. As an alternative, the heating apparatus 19 can also be arranged behind the panel 14.

As an alternative, the side of the partition wall 2, which side faces the cargo compartment 3, can at least in part comprise an intumescent coating in which or below which an electrical heating apparatus with as shallow a design height as possible, in particular small-diameter heating wires and/or a heating foil, is arranged. Advantageously the coating comprises a material thickness of less than 1 mm The heating apparatus 19 within the panel 14 is advantageously implemented with the use of sheetlike heating elements 20, in particular in the form of an electrically resistive foil, meandering heating wires spaced apart at short distances or the like.

The state of the coating of the grille 15, which in the case of fire is fully foamed, is indicated in a exaggerated manner in FIG. 1 by the irregular freehand-outline (with a dotted fill pattern). The surface of the initially completely planar panel 14 which surface faces the fire 5, foams in case of fire in a correspondingly irregular manner so as to protect the partition wall 2.

If the partition wall 2 is formed of adequately fire resistant panel elements, a protection by means of the intumescent panel 14 or an intumescent coating is in principle not necessary. However, since usually the panel elements abut each other and the cargo compartment delimitation, thus forming joints or gaps, the resulting joints or gaps can be covered by means of a ribbon-shaped electrically conductive fleece as a protective shield, which fleece comprises, or is coated with, an intumescent material. The electrically conductive fleece acts as a heating apparatus and in the case of fire causes controlled active swelling of the intumescent material in contact with it, and consequently any passing-through of combustion gases, for example as a result of joints or gaps between the panel elements widening as a result of the effect of the fire, is prevented. In the case of fire, changes in the width of the gaps or joints can, among other things, be caused by thermal deformation or distortion of the substructure of the partition wall 2. By means of such fleeces, in the case of fire, the cargo compartment can be hermetically sealed from the passenger compartment to stop combustion gases from passing through.

For example polyurethane or other plastic materials that can be painted on and/or applied by immersion can be considered as suitable intumescent materials for coating the grille 15, which plastic materials comprise suitable intumescent additives, for example the colloidal silicic acids, aluminium oxides, aluminium hydrates, aluminium silicates or other metal oxides mentioned in the introduction. Any merely intumescent coating applied to the partition wall 2, with an electrical heating apparatus that at least in some regions is integrated, without an intumescent panel 14 arranged in front of it, preferably comprises a corresponding composition.

As an alternative, the partition wall 2 can be covered with intumescent fleeces, woven materials or similar intumescent semifinished products.

Instead of the previously mentioned intumescent materials, a multitude of other intumescent materials or additives can be used in the production of the protective shields 12, 13.

As a result of the fire 5, as a rule, a temperature of 100° C. is quickly reached and exceeded in the region of a temperature sensor 21. In this case the heating apparatuses 18, 19 are activated by a control and regulating device 22 so that both the panel 14 and the grille 15 are quickly brought to the initialisation temperature of approximately 250° C., and the active fire protection with regard to the partition wall 2 and the pipe or duct 6 becomes effective as a result of the foaming action of the intumescent material, although in the region of the temperature sensor 21 the temperature is initially still relatively low at approximately 100° C. At the same time, as a result of the foaming intumescent coating of the grille 15, the pipe or duct 6 is safely sealed off against any passage of toxic combustion gases 16. Furthermore, as an alternative or in addition to temperature-controlled activation, manual triggering of the heating apparatuses 18, 19 by the cabin crew can be provided for. In this case, preferably at least one additional operating element, in particular an electrical switch, is arranged in the region of the passenger compartment and/or in the cockpit of the aircraft.

The limit temperature, from which the two heating apparatuses 18, 19 are self-actingly switched on by the control and regulating device 22, can preferably be set in an infinitely variable manner in a range of between 90° C. and 150° C., because the maximum permissible operating temperature of a (passenger) aircraft is generally around 80° C. In some circumstances, for triggering the heating apparatus 18, 19, therefore temperature sensors have to be provided, which are independent from the fire extinguishing system.

FIG. 2 shows a diagrammatic top view of a grille that is provided for the self-actingly, controlled closing-off of pipes or ducts, in particular of air conditioning or venting ducts, in aircraft in the case of fire.

A grille 23 for use within a pipe or duct with a quadrangular, round or oval cross section comprises two meandering resistive wires or electrically conductive heating wires 24, 25. The heating wires 24, 25, which are preferably through-coated with an intumescent material, form a multitude of recesses 26 for the air to be conditioned to flow through, which recesses 26 are not all designated with a reference character.

The two heating wires 24, 25 are used as heating apparatuses in order to, in the case of fire, by means of a heating current I_{Heiz}, quickly heat the grid 23 up to an initial temperature that is required for the intumescent material used, for example to 250° C., in order to bring about the intumescent reaction of the coating of the grid 23 already at a temperature range of between 90° and 150° C. in a controlled manner The intumescent coating of the grille 23 can comprise any suitable intumescent epoxy resin or an intumescent thermoplastic plastic material. As a result of the intumescent reaction the recesses 26 are quickly and completely closed by the action of foaming or expanding, and in this way the passage of “cold” combustion gases through the grille 23 in the case of fire is reliably prevented already at relatively low temperatures. In order to prevent short circuits between the heating wires 24, 25, it is, as a rule, necessary in each case to provide a high-temperature-resistant electrical insulation in intersections of the grille 23, of which only three insulation devices 27 or insulation elements comprise a reference character representative to the remaining ones.

Instead of the shown meandering arrangements of the two heating wires 24, 25, different installation arrangements can be selected in order to achieve heating up of the grille 23 as evenly, effectively, and quickly as possible. For example, prefabricated commercially available metal mesh or grilles can be used, into which an adequate number of heating wires are woven in.

Apart from their application as a firewall, wire mesh or grilles coated with an intumescent material can also be used to provide fire protection of electronic components, cable harnesses or pipe systems (in particular fuel lines and hydraulic lines). In this case, a wire mesh that is coated or equipped with such an intumescent material can be wrapped around the respective component or pipe or duct in the manner of a bandage.

The device according to the invention ensures active fire protection in a triggering range of between 90° C. and 150° C. with protective shields 12, 13 made of intumescent materials, although the initial temperatures of such materials are presently, as a rule, around approximately 250° C.

### LIST OF REFERENCE CHARACTERS

1 Device
2 Partition wall
3 Cargo compartment (aircraft)
4 Passenger compartment (aircraft)
5 Fire
6 Pipe or duct
7 Connection opening (partition wall)
8 Blower
9 Arrow
10 Arrow
11 Apparatus (air conditioning apparatus)
12 Protective shield
13 Protective shield
14 Panel
15 Grille
16 Combustion gas
17 Heating wire
18 Heating apparatus
19 Heating apparatus
20 Sheetlike heating element (e.g. electrically resistive foil)
21 Temperature sensor
22 Control and regulating device
23 Grille
24 Heating wire
25 Heating wire
26 Recess
27 Insulation (insulation element)

1. A device for active fire protection in an aircraft comprising:
at least one protective shield, wherein the at least one protective shield comprises an intumescent material that in case of fire is activatable with an electrical heating apparatus;
wherein a fire region is separated from a protected region with a partition wall having at least one connection opening in which the protective shield is arranged in order to close the at least one connection opening in case of fire; and
wherein, in a non-activated state, the at least one protective shield in the at least one connection opening comprises a plurality of recesses for gases to flow through.

2. The device of claim 1, further comprising at least one temperature sensor connected to a control and regulating device in order to monitor the temperature in the fire region.

3. The device claim 1, further comprising a control and regulating device adapted to turn on the electrical heating apparatus when the temperature ranges from 90° C. to 150° C. by in order to initiate controlled foaming of the intumescent material.

4. The device of claim 1, wherein the intumescent material self-actingly foams at a temperature of 250° C.

5. The device of claim 1, wherein the electrical heating apparatus comprises at least one heating wire.

6. The device of claim 1, wherein the electrical heating apparatus comprises at least one sheetlike heating element.

7. The device of claim 1, wherein the fire region is a cargo compartment of the aircraft;
wherein the protected region is a passenger cabin of the aircraft;
wherein the at least one connection opening is a pipe or duct,
wherein the at least one protective shield is positioned in the at least one connection opening in order to close the at least one connection opening in a pressure-tight manner in case of fire.

8. The device of claim 1, wherein the at least one protective shield comprises at least one panel that at least in some regions is formed by the intumescent material.

9. The device of claim 1, wherein the at least one protective shield comprises at least one grille that at least in some regions is coated with the intumescent material.

10. The device of claim 7, wherein at least one component in a region of the cargo compartment is at least partly coated with the intumescent material.
